(19) United States
(12) Patent Application Publication
(10) Pub. No.: US 2005/0236245 A1
(43) Pub. Date: Oct. 27, 2005

(54) Clutch with wear ring

(75) Inventors: Kevin L. Maurice, Bristol, CT (US); Stephen E. Nyquist, Simsbury, CT (US); Kenneth G. Bosley, Torrington, CT (US)

Correspondence Address: EDWARDS & ANGELL, LLP, P.O. BOX 55874, BOSTON, MA, 02205, US

(73) Assignee: Inertia Dynamics, Inc.

(21) Appl. No.: 11/115,903

(22) Filed: Apr. 26, 2005

Related U.S. Application Data
(60) Provisional application No. 60/565,860, filed on Apr. 27, 2004.

(51) Int. Cl. F16D 67/06; F16D 27/105

(52) U.S. Cl. 192/17 C; 192/17 D; 192/12 D; 192/84.81

(57) ABSTRACT

A wear ring that surrounds a friction disk to improve the life and performance of a clutch. The wear ring may further facilitate braking action. A hub retains a helical spring that wraps down upon the wear ring to actuate the clutch. The helical spring is at least partially retained by a lip formed on the hub.

### CROSS-REFERENCE TO RELATED APPLICATION

This application claims priority to U.S. Provisional Patent Application No. 60/565,860, filed Apr. 27, 2004, which is incorporated herein by reference in its entirety.

### BACKGROUND

1. Field of the Invention

The subject invention relates to systems for clutches and brakes, and more particularly to an improved clutch and brake assembly. Use of clutches has been widely used and well understood in the art.

2. Background of the Related Art

Clutches are used generally to control the transmission of torque between rotating machine elements. Positive clutches, when engaged, lock the elements together to rotate as one. Such clutches are partially “self-energizing” to the extent that the force of engagement increases as the torque between the shafts increases.

It is known to those skilled in the art to produce electrical, self-energizing, positive clutches utilizing a helical spring attached at one end to one rotating machine element, and electromagnetically attracted to the second rotating machine element by an electromagnetic coil when the clutch is to be activated. The attraction causing wrapping down of the helical spring about an outer diameter of an annular wedge of frictional material to press an inner diameter of the frictional material into frictional linking with another element. The helical spring and the wedge shape of the frictional material define a mechanical advantage that may allow a relatively low force of attraction between the electromagnet and the helical band to nevertheless provide a high torque coupling of the two machine elements in a desirable manner.

Often it is desirable, when the clutch is disengaged, to lock the driven machine element in place to prevent free-wheeling. Examples of such clutches are found in U.S. Pat. No. 6,047,805 issued Apr. 11, 2000 and U.S. Pat. No. 6,488,133 issued Dec. 3, 2002, each of which is hereby incorporated by reference. Despite these significant advances, use of clutches, brakes and combinations thereof results in undesirably quick wear that necessitates replacement of one or more components. In view of this, there is a need for an improved performance and a longer lasting clutch, brake and combinations thereof.

### SUMMARY

It is an object of the subject technology to provide a wear ring that distributes load over a broader area before transmitting the load to a radially inward friction material. It is an object of the subject technology to allow the wear ring to rotate relative to the underlying friction material so that loading on the friction material from the rotational motion is decreased and the wear surface is increased as compared to having the spring interfacing directly with the friction material.

It is an object of the subject technology to provide a wear ring that also acts like a spring to counteract the torque capability of the clutch while at the same time increasing its ability to release when disengaged. Additionally, the subject technology improves performance improvements, wear and stress.

The subject technology is further directed to the wear ring having a radial split and/or hollows to facilitate compression and other features to facilitate braking action.

In one embodiment, the subject technology is directed to an electric clutch system including a fixed field cup having an electromagnetic coil, a rotor mounted to rotate about an axis of rotation, wherein the rotor has a pole face, a hub mounted to independently rotate about the axis, wherein the hub has a a helical spring opposing the pole face, a wear ring sized and configured to fit within the helical spring and a friction disk sized and configured to fit within the wear ring. The helical spring is sized and positioned such that when current flows through the electromagnetic coil, the helical spring is drawn to the pole face and frictionally linked therewith causing the helical spring to wrap down onto the wear ring and, in turn, the wear ring and the friction disk compress to rotationally link the rotor and hub.

In another embodiment, the subject technology is directed to a hub that provides a lip for facilitating coupling a helical spring thereto in order to reduce stress in the clutch assembly.

### BRIEF DESCRIPTION OF THE DRAWINGS

So that those having ordinary skill in the art to which the disclosed system appertains will more readily understand how to make and use the same, reference may be had to the drawings as follows.

FIG. 1 is an exploded perspective view showing the components of a clutch and brake assembly of a preferred embodiment.

FIG. 1A is another somewhat exploded perspective view of a hub, wear ring and friction disk that are useful in the assembly of FIG. 1.

FIG. 2 is a plan view of a hub that is useful in the assembly of FIG. 1.

FIG. 2A is a cross-sectional view along line A-A of the hub of FIG. 2.

FIG. 3A is a perspective view of a wear ring that is useful in the assembly of FIG. 1.

FIG. 3B is a side view of the wear ring of FIG. 3A.

FIG. 3C is a front view of the wear ring of FIG. 3A.

FIG. 4A is a front perspective view of a friction disk that is useful in the assembly of FIG. 1.

FIG. 4B is a back perspective view of a friction disk useful in the assembly of FIG. 1.

FIG. 4C is a front view of the friction disk of FIG. 4A.

FIG. 4D is a cross-sectional view along line D-D of the friction disk of FIG. 4A.

FIG. 5 is an assembled side view of the assembly of FIG. 1.

FIG. 5A is a cross-sectional view along line A-A of the assembly of FIG. 5.

FIG. 6 is an assembled front view of the assembly of FIG. 1.

FIG. 6A is a cross-sectional view along line A-A of the assembly of FIG. 6.

FIG. 6B is a fragmentary view of FIG. 6A.

FIG. 7 is an exploded perspective view showing components of another embodiment of a clutch assembly in accordance with the subject technology.

FIG. 8 is an exploded perspective view in half cross-section showing the components of the clutch assembly of FIG. 7.

FIG. 9A is a perspective view of a wear ring that is useful in the assembly of FIG. 7.

FIG. 9B is a front view of the wear ring of FIG. 9A.

FIG. 9C is a cross-sectional view along line C-C of the assembly of FIG. 9B.

It should be appreciated that the present invention can be implemented and utilized in numerous ways, including without limitation as a process, an apparatus, a system, a device, and a method for applications now known and later developed. These and other unique features of the system disclosed herein will become more readily apparent from the following description and the accompanying drawings.

### DETAILED DESCRIPTION OF PREFERRED EMBODIMENTS

The present technology overcomes many of the prior art problems associated with clutch wear and performance as well as the same for brake and clutch combination assemblies. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference names identify similar structural elements.

The preferred embodiments utilize many of the same principles as the clutch system and method of U.S. Pat. No. 6,488,133 and for simplicity and brevity, such principles are not repeated herein. However, it would be appreciated by those of ordinary skill in the pertinent art that the preferred embodiments are provided as examples and the subject technology is not limited to such examples.

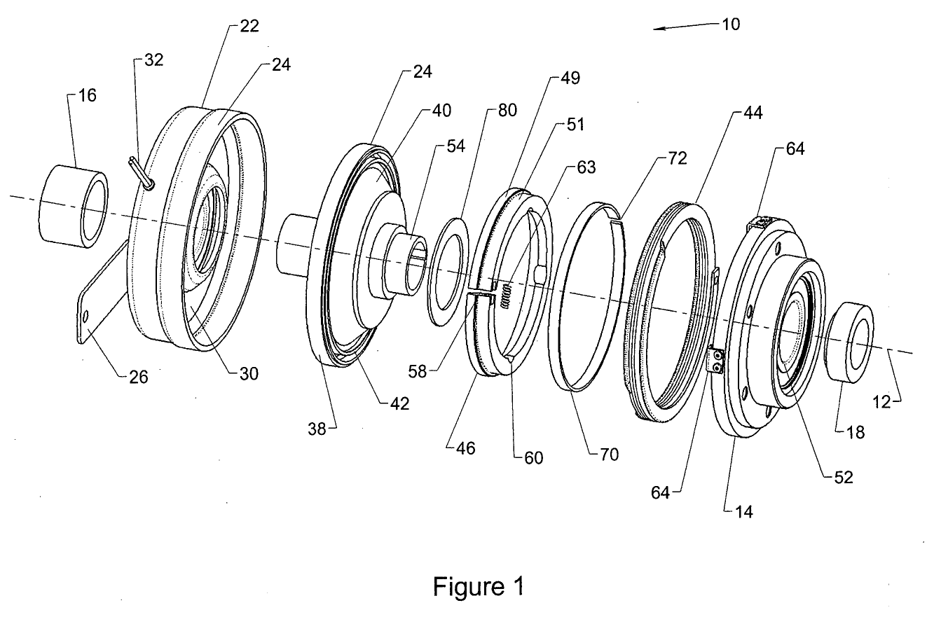

Referring to FIG. 1, the clutch and brake assembly 10 of the present technology when engaged, connects a drive shaft (not shown) extending along an axis 12 of rotation to a hub or pulley 14. The drive shaft and hub 14 interface with adapter sleeves 16 and 18, respectively, that interact with bearings. A field cup 22 opening toward a front of the clutch and brake assembly 10 has a tubular outer wall 24 coaxial with axis 12. The field cup 22 is partially closed at a rear end that defines a central rearward opening recess 20 which supports the outer surface of a bearing. Field cup 22 includes an anti-rotation tab 26 for mounting in a stationary position with respect to the drive shaft and hub 14. Positioned within the field cup 22, coaxial with axis 12 and around the recess 20, is an electromagnet coil 30. The electromagnet coil 30 has leads 32 so that current may be passed through electromagnet coil 30 to create a magnetic field extending along axis 12.

Fitting within the tubular outer wall 24 of field cup 22 is a rotor 34 that turns with the drive shaft. The outside diameter of rotor 34 provides an annular cylindrical wall 38 adjacent to the inner surface of tubular outer wall 24 of the field cup 22. The rotor 34 is adapted and configured to create a magnetic path for flux passing therethrough. The front surface of the rotor 34 forms a pole face 42 against which an adjacent winding of a coaxial helical spring 44 may be drawn when the electromagnet coil 30 is actuated. The pole face 42 is generally perpendicular to the axis 12. Radially inside the pole face 42 is a sloping friction surface 40 forming a truncated cone extending forward over the drive shaft 12. In a preferred embodiment, the helical spring 44 has individual windings or coils with a generally rectangular cross-section. The helical spring 44 has coils lying generally within a plane perpendicular to axis 12 and adjacent to pole face 42 of rotor 34.

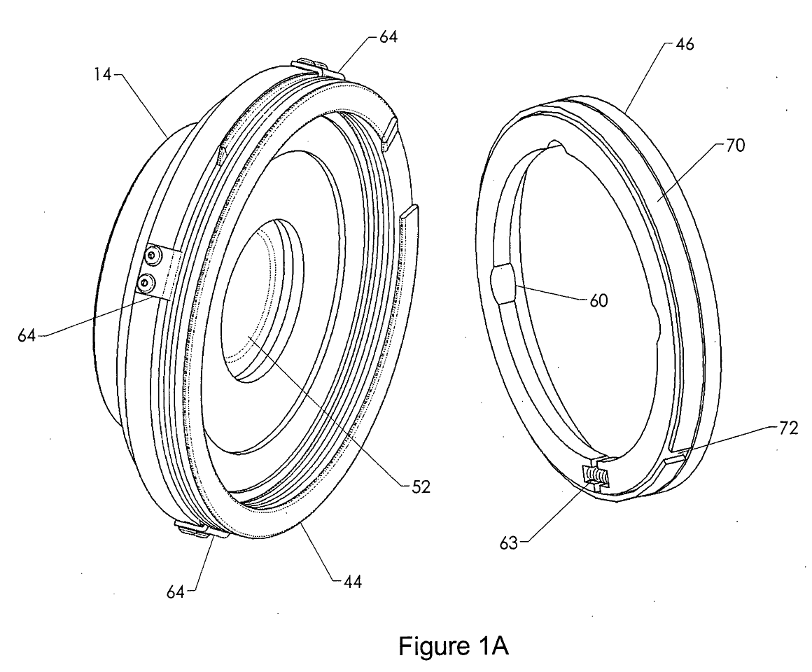

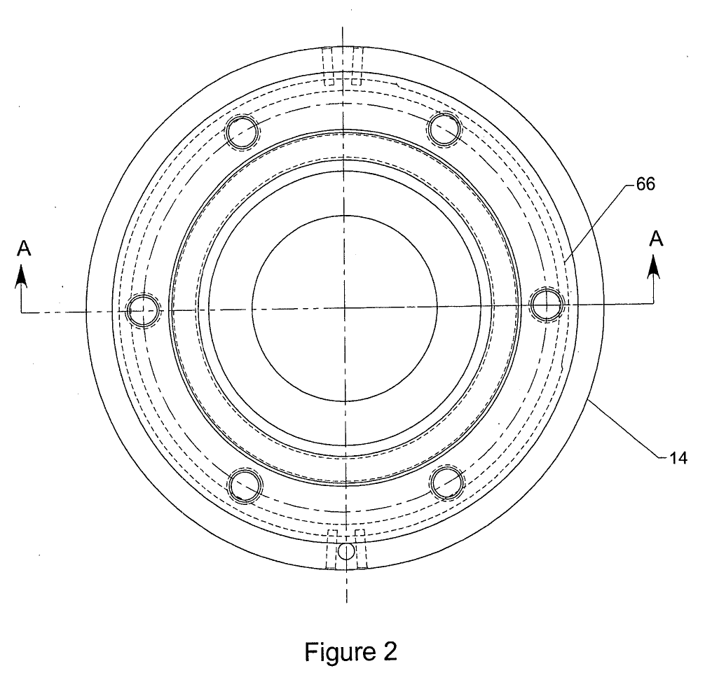

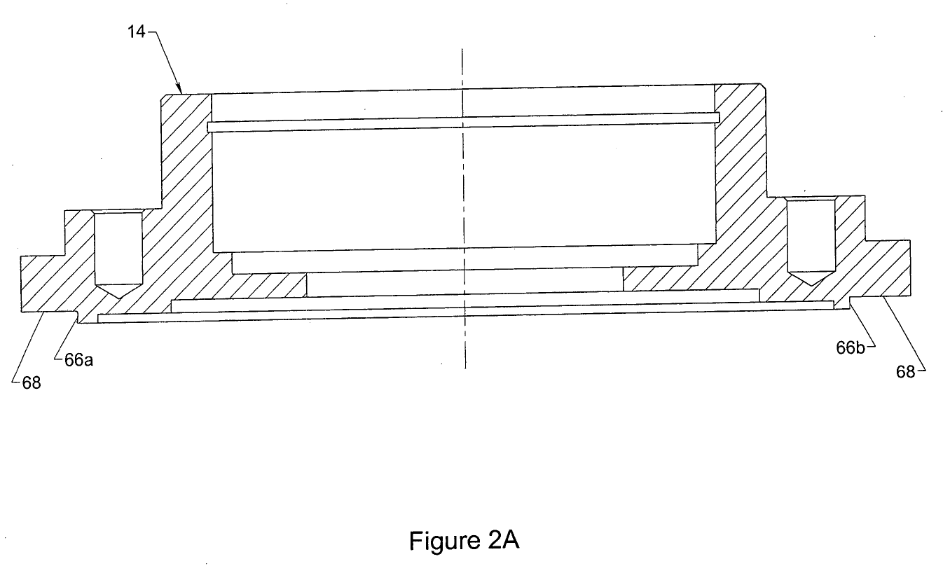

Referring also to FIGS. 1A, 2 and 2A as well as FIG. 1, the hub 14 is assembled to the brake clutch 10 by means of the bearing fitting over a front protruding support surface 54 of the rotor 34. The inside of the bearing is supported on the support surface 54 and the outside of the bearing fits within a bore 52 in the hub 14. A plurality of spring retainers 64 secure about the outside diameter of the hub 14 to attach the helical spring 44 thereto. Preferably, three spring retainers 64 retain a single adjacent winding of the helical spring 44 to the hub 14.

Further, to help secure the helical spring 44 to the hub 14, a lip 66 on the hub 14 rotationally links the helical spring 44 to the hub 14. The lip 66 allows the helical spring 44 to grip or wrap down on the hub 14 when the helical spring 44 is electromagnetically drawn and frictionally linked to the pole face 42, i.e., wrapped down in the same direction of rotation as normal operation. In a preferred embodiment, the lip 66 is adapted and configured to engage a single adjacent winding of the helical spring 44 axially. The axial retention provided by the lip 66 reduces axial stress on the spring retainers 64 that hold the helical spring 44 in place. In another embodiment, the lip 66 engages multiple windings. In another embodiment, a taper on the lip 66 causes the helical spring 44 to be driven against the adjacent flat hub wall 68 as the helical spring 44 wraps down to further enhance the rotational linking action. In still another embodiment, the helical spring 44 is sized to grip the lip 66 when relaxed.

Preferably as best seen in FIG. 2A, a relieved portion of the lip 66 allows a smooth transition as the spring radially closes down after the spring has wrapped around more than 50% of a full turn, and axially passes above the lip 66 approximately at the beginning of the second turn of helical spring 44. In other words, the lip 66 does not have a consistent profile. For example, lip 66a has an outward taper with respect to the hub 14. In contrast, lip 66b has a substantially straight profile and less material in the radial cross section.

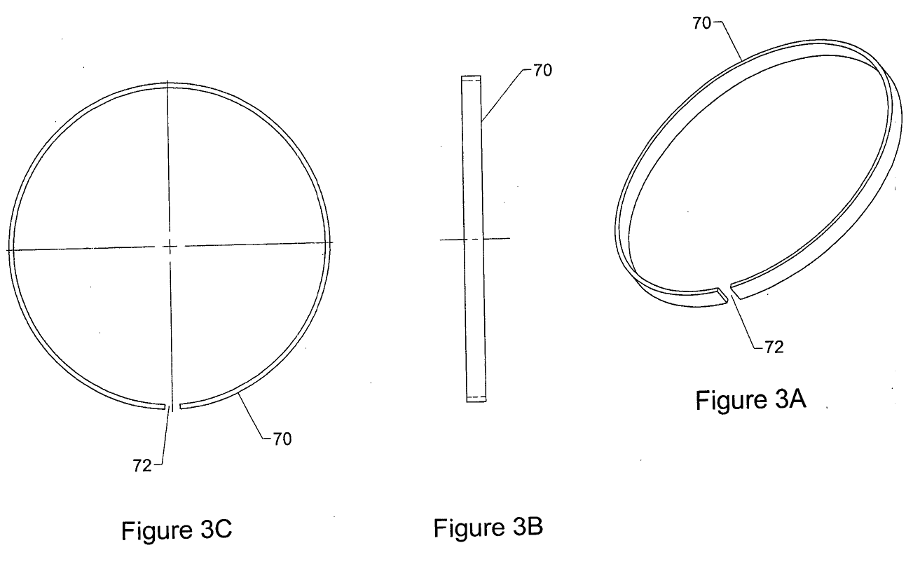

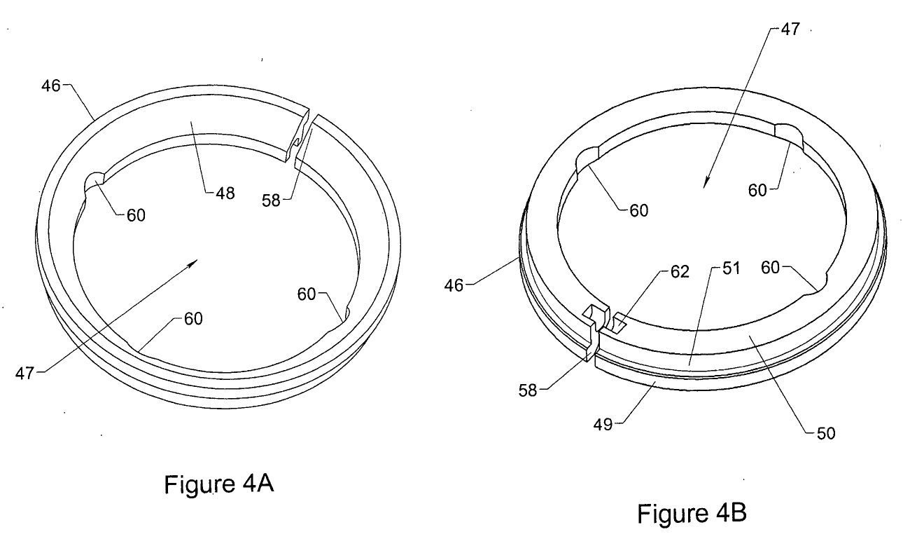

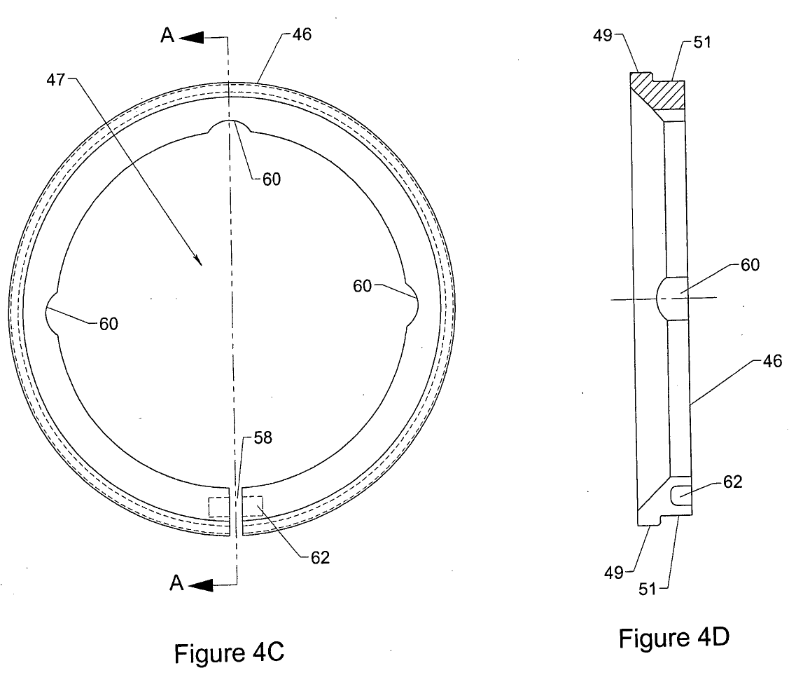

Referring now to FIGS. 1A and 3A-C as well as FIG. 1, a wear ring 70 and friction disk 46 fit radially within the helical spring 44. The wear ring 70 is sized and configured to partially surround the friction disk 46 and couple to an outside diamter of the friction disc 46 when the inner diameter of the helical spring 44 wraps down thereon. The wear ring 70 is a substantially circular band that defines an axial split 72 to allow the wear ring 70 to collapse in diameter when compressed by the helical spring 44. In a preferred embodiment, the wear ring 70 is steel. In still another embodiment, the wear ring is sized and configured to fully surround or even over-sized with respect to the friction disk 46.

Preferably, the wear ring 70 is a stronger material relative to the friction disk 46 in order to better withstand the high PSI loading that the windings of the helical spring 44 place thereon. The wear ring 70 distributes this loading over a broader area before transmitting the load to the friction disk 46 radially within. In a preferred embodiment, the wear ring 70 rotates independently of the friction disk 46 so that independent rotational motion of the wear ring 70 can occur as the helical spring 44 wraps down or releases and rewinds to a relaxed/deengergized state. It is also envisioned that in other embodiments, the wear ring 70 is bonded, keyed or otherwise secured to the friction disk 46. In another embodiment, the wear ring is a composite material such as a relatively soft radially inward material surrounded by a relatively harder outer material to faciliate tight tolerances and longer life. It is also envisioned that the soft radially inward material may compress and, thus, a radial gap is optional. In still another embodiment, the harder outer material completely encases the soft inner material.

Further, the wear ring 70 is selected to optimize the performance of the clutch and brake assembly 10. By varying the material, length, thickness, an area and/or resistance of the wear ring 70, the wear ring 70 acts like a spring. The stiffer the spring action of the wear ring 70, the more the wear ring 70 counteracts the clutching torque capability of the assembly 10 while at the same time increasing the ability of the assembly 10 to release when deenergized. It is also envisioned that the helical spring 44 and/or the wear ring 70 may have various coatings to further acheive different performance characteristics. For example, a coating can be used to enhance dynamic torque, static torque, corrosion resistance, wear resistance, and the like. Without limitation, the helical spring 44 and/or the wear ring could be coated with a zinc plating, paint, teflon and the like as would be known to one of ordinary skill in the art based upon review of the subject disclosure.

Referring now to FIGS. 1, 1A as well as 4A-D, by surrounding and protecting the friction disk 46 with the wear ring 70, the friction disk 46 can be a standard composite friction material and still provide the torque transmittal within the assembly 10 with the high strength and endurance of the wear ring 70. Of course, relatively weaker or stronger materials could also still be used for the friction disk 46 while still utilizing the same benefits of the wear ring 70. Preferably, the friction disk 46 is a single-piece ring split with a radial gap 58 and hollows 60. The radial gap 58 allows the disc to flex radially.

The friction disk 46 also defines a central aperture 47 to allow free rotation of the drive shaft and rotor 34 absent any compression of the friction disk 46 against the sloping friction surface 40 of the rotor 34. The friction disk 46 is approximately equal in diameter to the sloping surface 40 of the rotor 34 with a diagonal face 48 generally conforming to the sloping surface 40 when the friction disk 46 is arranged coaxially about the axis 12 between the rotor 34 and the hub 14. A radial face 50 of friction disk 46 is adjacent the hub 14 and a generally opposing diagonal face 48 of the friction disk 46 abuts the sloping surface 40. When the friction disk 46 is compressed, the diagonal face 48 makes surface contact with and presses against the sloping surface 40 and establishes a frictional linking between the rotor 34 and the hub 14. The surface contact is more uniform due to the three hollows 60 that allow flexing and relief to conform to the sloping surface 40 with minimal resistance.

Within the radial gap 58, the friction disk 46 forms a slot 62 for retaining a return spring 63. The return spring 63 facilitates disengagement. The return spring is compressed as the friction disk 46 is compressed by the helical spring 44. When the helical spring 44 is magnetically disengaged to stop compressing the friction disk 46, the return spring 63 provides a force to return the friction disk 46 to normal size and, thereby, assist in disengaging the friction disk 46 from the rotor 34. As a result of the return spring 63, drag is reduced. In another preferred embodiment, the friction disk (not shown) is a two piece friction disc (two halves) and is loaded with two springs in radial slots approximately 180 degrees apart. In still another embodiment, multiple springs are loaded in each radial slot.

The friction disk 46 has a radially outward edge 49 aligned with the axis 12 opposing the inner edge of the helical spring 44. Preferably, the outward edge 49 defines an annular groove 51 for receiving the wear ring 70. A decrease in the effective diameter of the helical spring 44 (e.g., as may be caused by torsion of the helical spring 44) compresses the wear ring 70 and, in turn, the friction disk 46 to frictionally lock the rotor 34 and hub 14 together.

Referring again to FIG. 1, a felt washer 80 rests between the rotor 34 and hub 14. The felt washer 80 helps prevent friction dust from contaminating the ball bearing in the hub 14 as well as preventing ball bearing grease from contaminating the friction disk 46. Preferably, the felt washer 80 is sized and configured to fit within the friction disk 46.

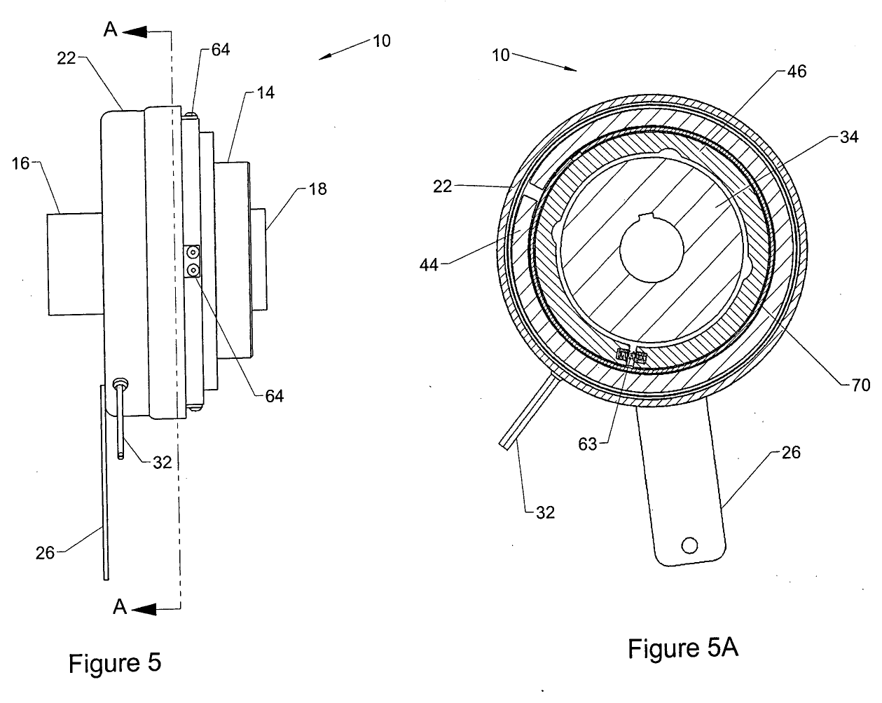

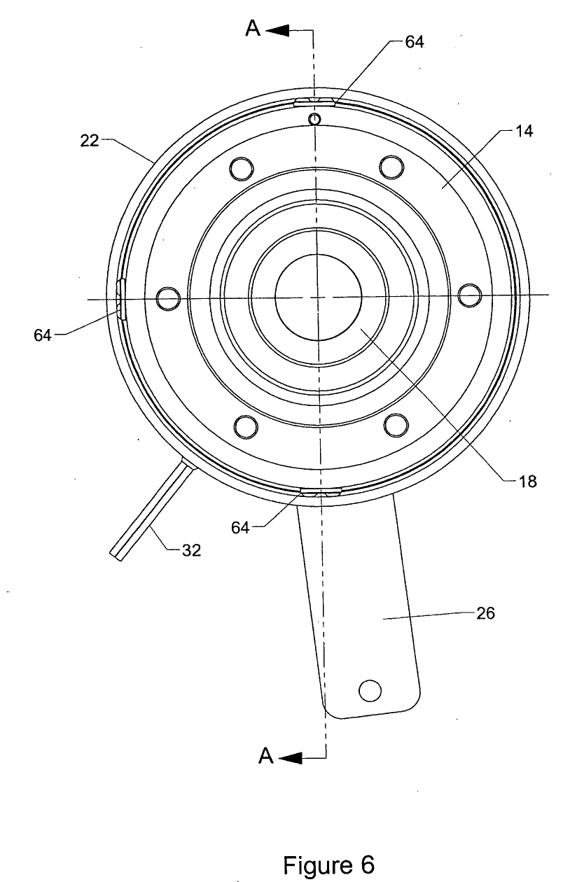

Referring now to FIG. 5, a side view of the competed assembly 10 is shown. Referring also to FIG. 5A, a cross-sectional view along line A-A of FIG. 5 is shown with the assembly 10 in a deenergized state. As can be seen best in FIG. 5A, the field cup 22 contains the rotor 34 at least partially within the friction disk 46 that is at least partially within the wear ring 70 that is within the helical spring 44 attached to the hub 14. If the helical spring 44 is so sized and configured to have an outer diameter slightly larger than the field cup 22, the helical spring 44 may couple to the field cup 22 to act as a brake. Alternatively, if the helical spring 44 is so sized and configured to have an outer diameter smaller than the field cup 22, the assembly 10 only acts as a clutch.

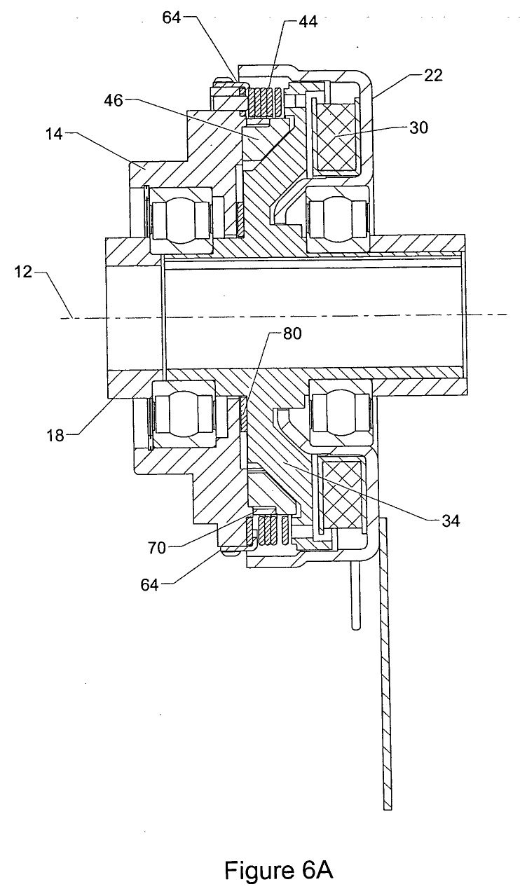

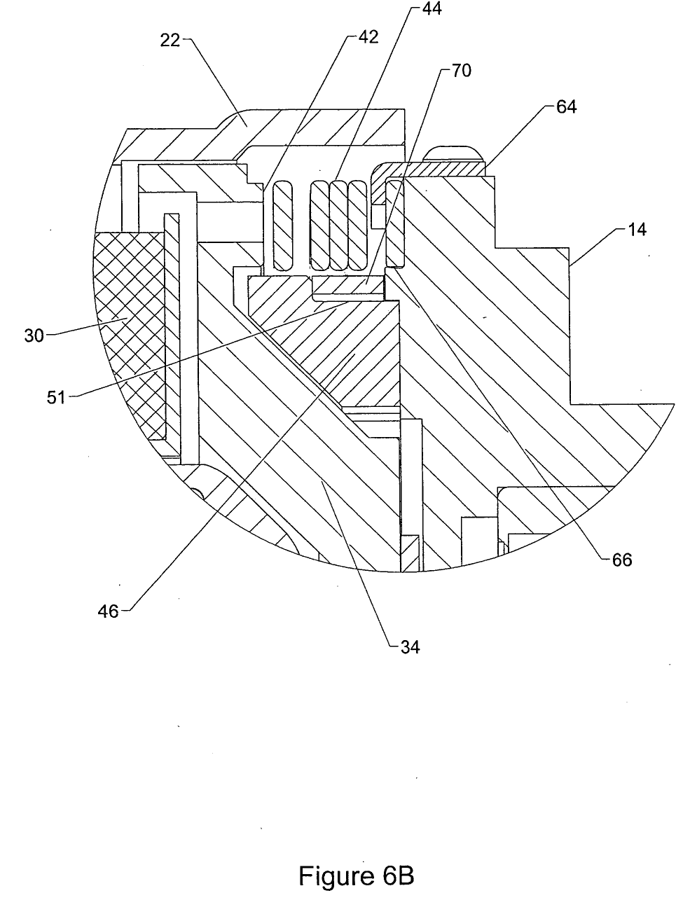

Referring now to FIG. 6, a front view of the completed assembly 10 is shown. Referring also to FIGS. 6A and 6B, a cross-sectional view and partial cross-sectional view, respectively, along line A-A of FIG. 5 are shown. When the electromagnet coil 30 is energized, magnetic flux draws the helical spring 44 to the rotor 34. The attraction causes a frictional linking between the helical spring 44 and pole face 42 of the rotor 34. The winding of the helical spring 44 and the loading of the drive shaft and hub 14 is such as to tighten the windings of the helical spring 44 causing the helical spring 44 to contract and, thereby, reduce in diameter or wrap down upon the lip 66 of the hub 14 and the wear ring 70 as well as partially directly on the friction disk 46 if so configured. The wrapping down of the helical spring 44 compresses the wear ring 70 so that the wear ring 70 and friction disk 46 compress. During compression, the compressive force of the helical spring 44 is very evenly distributed on the friction disk 46, which compresses downward against the rotor 34 to frictionally link, clutch or wedge the hub 14 to turn with rotor 34 and thus with the drive shaft. When the electromagnet coil 30 is shut off, the return spring 63 and wear ring 70 both facilitate return of the friction disk 46 to normal size and, thereby, the clutching action of the assembly 10 is released.

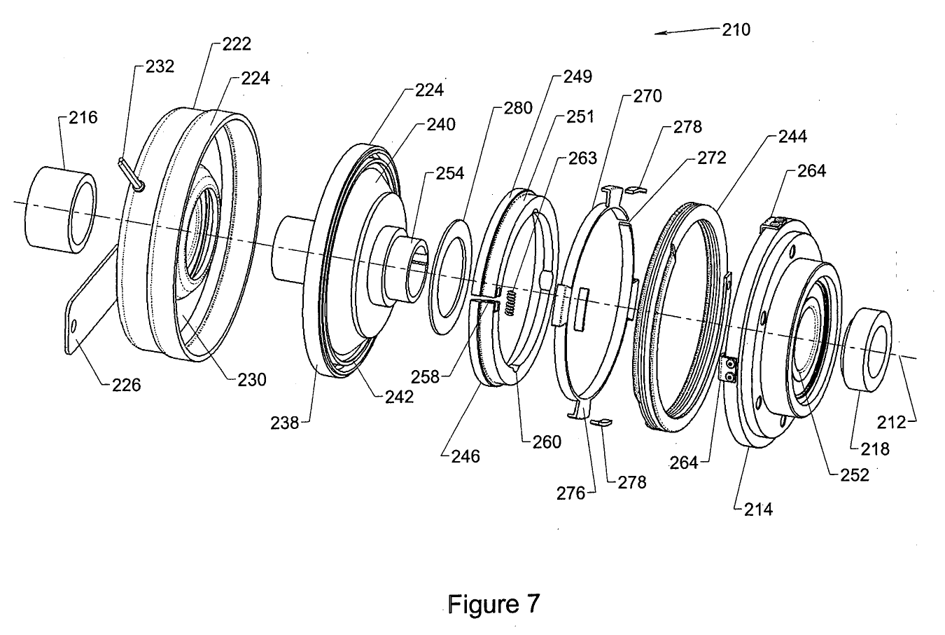

Now referring to FIGS. 7-9C, another embodiment of an assembly 210 and components are shown. As will be appreciated by those of ordinary skill in the pertinent art, the assembly 210 utilizes many of the same principles of the assembly 10 described above. Accordingly, like reference numerals preceded by the numeral “2” instead of the numeral “1” are used to indicate like elements whenever possible. For simplicity, the following description is largely directed to the different wear ring 270. The assembly 210 is designed to improve upon the braking action created by the metal to metal contact of the helical spring 244 against the field cup 222 and heat and wear generated thereby.

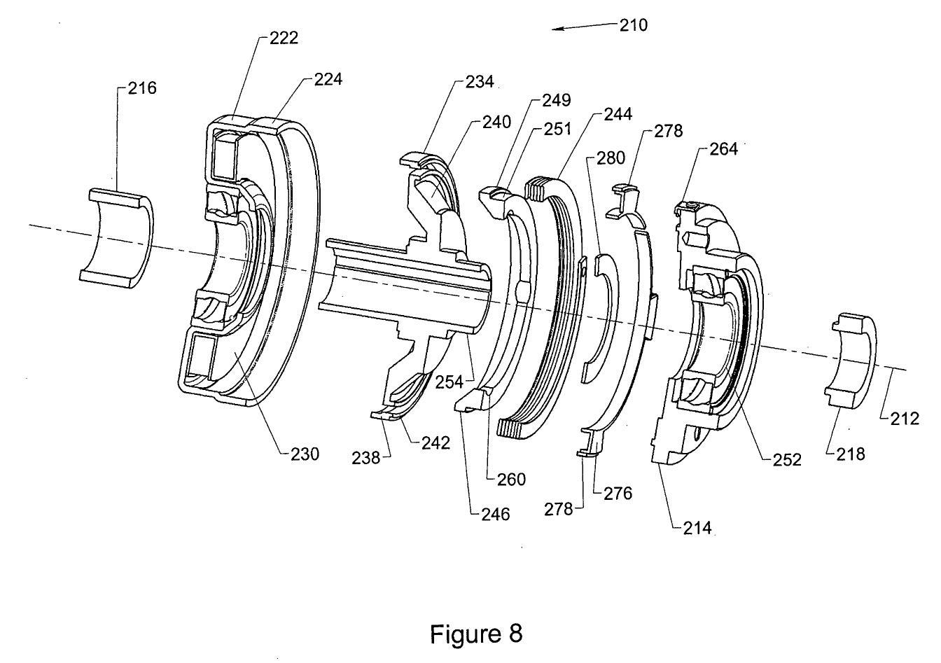

Referring now to FIGS. 7 and 8, exploded perspective view and an exploded cross-sectional view showing the components of the assembly 210 are shown, respectively. The braking capacity of the assembly 210 is enhanced by adding one or more brake features 274 on the wear ring 270. Although four brake features 274 are shown, it will be appreciated by those of ordinary skill in the art that a different number and size of brake features can be used to vary cycle life and performance.

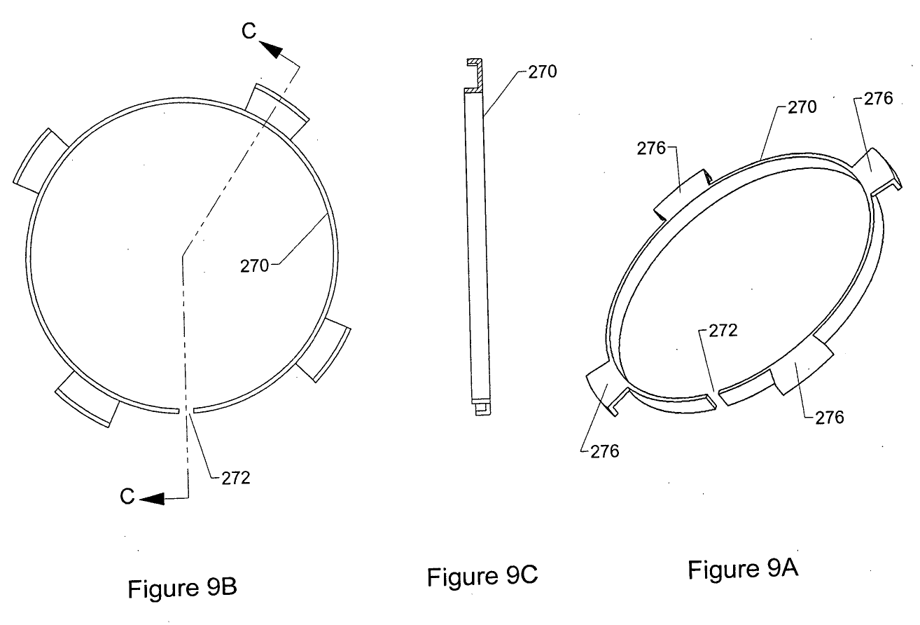

Referring as well to FIGS. 9A-9C that show a portion of the wear ring 270, the brake features 274 include a C-shaped cross section flange 276 that encompasses a portion of the helical spring 244. Preferably although not necessary, a brake shoe 278 is bonded to an outer edge of each flange 276. In a preferred embodiment, the brake shoe 278 is a friction material used to improve performance. The brake shoes 278 provide a lubricated engagement as opposed to metal on metal and the brake action is softened in a desirable manner. In a preferred embodiment, the brake shoes 278 are composed of a composite friction material well know to those of ordinary skill in the art.

Generally, the wear ring 270 is coupled to the hub 214 and sized in a relaxed state so that the outer diameter of the helical spring 244 is within the flanges 276 and the outer radial edge of helical spring 244 presses radially outward against the flange 276. As a result, the helical spring 244 forces the brake shoes 278 against the field cup 222 to effectively brake the hub 214 against field cup 222. In one embodiment, the wear ring 270 is coupled to the hub 214 by having a portion of the flanges 276 placed within the windings of the helical spring 244. In another embodiment, the flanges 276 are not between the windings.

Although, the helical spring 244 provides energy, the brake force is transmitted from the field cup 222 to brake shoes 278 to the helical spring 244 and, in turn, to the hub 214. In another embodiment, the wear ring 270 is sized and configured to provide brake force. In still another embodiment, the wear ring 270 and helical spring 244 in combination provide the brake force. The brake shoes 278 may be integral to the wear ring 270 or work along side the wear ring 270. It is possible that both the brake shoes 278 and the wear ring 270 are made up of several segements.

As the helical spring 244 wraps down and compresses the wear ring 270, the brake features 274 follow the radial movement of the helical spring 244. In other words, the helical spring 244 pulls the brake shoes 278 radially inward, away from the field cup 222 thus allowing the hub 214 to rotate freely. Once again, as the wear ring 270 is compressed, the friction disk 246 compresses and linking or clutching of the rotor 234 to the hub 214 occurs similarly to that noted above.

In another embodiment, the wear ring attaches to the helical spring with a spot weld and acts to control the rotation of the friction disk with respect thereto. Preferably, the return spring couples between a bent end of the wear ring that extends into the radial gap 58 and the opposing side of the radial gap 58. Such bent end may be bowed or otherwise configured to bias the radial gap 58 open, i.e., to act as a spring instead of the retainer spring 63. In another embodiment, the friction disk is three identical segments which form an arc. Each segment defines a hollow at one end to receive a return spring, approximately one hundred twenty degrees apart, that may or may not interact with the wear ring. Although several friction disks are disclosed, it will be recognized by those skilled in the art that many other variations exist for the configuration of friction disk including, but not limited to, a two piece or four piece construction or any other construction that would function in this environment.

In another embodiment, a friction material disposed on the field cup facilitates linking of the outer diameter of the helical spring or wear ring as the case may be. Further, it will be understood that the inward and outward direction of the helical spring may be reversed with the helical spring having a bias inward to normally compress friction disk inward with the action of the rotor unwinding the helical spring to cause frictional linking between the helical spring and the field cup.

While the invention has been described with respect to preferred embodiments, those skilled in the art will readily appreciate that various changes and/or modifications can be made to the invention without departing from the spirit or scope of the invention as defined by the appending claims.

1. An electric clutch system comprising:
a rotor mounted to rotate about an axis of rotation, wherein the rotor has a pole face;
a hub mounted to independently rotate about the axis, wherein the hub has a helical spring opposing the pole face;
a wear ring sized and configured to fit within the helical spring; and
a friction disk sized and configured to fit within the wear ring,
wherein the helical spring is sized and positioned such that when current flows through the electromagnetic coil, the helical spring is drawn to the pole face and frictionally linked therewith causing the helical spring to wrap down onto the wear ring and, in turn, the wear ring and the friction disk compress to rotationally link the rotor and hub.

2. The system of claim 1, wherein the wear ring has a radial split.

3. The system of claim 1, wherein wear ring is sized and positioned such that when no current flows through the electromagnetic coil, the wear ring relaxes and causes a braking action on the fixed field cup.

4. The system of claim 3, further comprising a plurality of brake features on the wear ring.

5. The system of claim 1, wherein the wear ring rotates independently.

6. The system of claim 1, further comprising a coating on the wear ring.

7. The system of claim 1, wherein the wear ring partially surrounds the friction disk.

8. The system of claim 7, wherein the friction disk defines a groove for receiving the wear ring.

9. The system of claim 1, further comprising a felt washer between the rotor and hub.

10. The system of claim 1, wherein the friction disk defines a plurality of hollows to facilitate mating during compression.

11. The system of claim 1, wherein the friction disk defines a radial gap that contains a return spring.

12. The system of claim 1, wherein a portion of the wear ring extends into a radial gap of the friction disk and acts as a return spring.

13. The system of claim 1, wherein the helical spring is sized and positioned such that when no current flows through the electromagnetic coil, the helical spring relaxes and causes a braking action on the fixed field cup.

14. The system of claim 1, wherein the hub defines a lip for coupling to a winding of the helical spring and the lip is tapered.

15. The system of claim 1, wherein the wear ring is a composite material fabricated from a soft inner material bonded to a relatively harder outer material.

16. A wear ring for use in a clutch system having a friction disk, the wear ring comprising:
a circular band sized and configured to at least partially surround the friction disk and compress therewith while reducing stress upon the friction disk.
